(19) United States
(12) Patent Application Publication
(10) Pub. No.: US 2023/0394119 A1
(43) Pub. Date: Dec. 7, 2023

(54) UNSUPERVISED MACHINE LEARNING LEVERAGING HUMAN COGNITIVE ABILITY LEARNING LOOP WORKFLOW

(71) Applicant: Booz Allen Hamilton Inc., McLean, VA (US)

(72) Inventors: John O'Neil CASWELL, Columbia, MD (US); Ria Leilani Ramirez BALDEVIA, Columbia, MD (US); Devin Tadao TAMASHIRO, Annapolis Junction, MD (US)

(73) Assignee: Booz Allen Hamilton Inc., McLean, VA (US)

(21) Appl. No.: 18/322,643

(22) Filed: May 24, 2023

Related U.S. Application Data
(60) Provisional application No. 63/348,210, filed on Jun. 2, 2022.

(51) Int. Cl. G06F 18/2431; G06F 18/23

(52) U.S. Cl. CPC G06F 18/2431; G06F 18/23

(57) ABSTRACT

Disclosed is a method for developing a model to classify data. The method involves receiving plural data points, grouping each data point into one or more groups via a clustering algorithm, assigning each data point an index based one or more groups into which each data point is grouped, and classifying all indexed-data points of a group and labelling the classified indexed-data points of the group with the same label. Also disclosed is a method for classifying data. The method involves receiving incoming data points, comparing the incoming data points to a corpus of labelled data points, the corpus of labelled data points including data points that have been grouped via a clustering algorithm and labelled with a same label, and labeling an incoming data point with a label based on a match between the incoming data point and a labelled data pack.

### CROSS-REFERENCE TO RELATED APPLICATIONS

This patent application is related to and claims the benefit of priority to U.S. provisional patent application No. 63/348,210, filed on Jun. 2, 2022, the entire contents of which is incorporated by reference.

### FIELD

Embodiments relate to systems and methods for building and implementing a model for batch labelling data.

### BACKGROUND INFORMATION

Known systems for labeling data rely on methods of classifying data on an individual data point by data point basis. These methods are time consuming, require relatively, large computational resources, and can result in inaccuracies.

### SUMMARY

Embodiments relate to systems and methods that leverage unsupervised, supervised, and hybrid Machine Learning (ML) approaches to accelerate automated data classification. The systems and methods can be built on models and algorithms that help end users understand amalgamous data, parse, and categorize data at a greater velocity.

While the disclosed systems and methods provide the end user with the ability to quickly analyze any type of data, it can be particularly beneficial when applied to complex high-dimensionality data that is not uniform in data schema or structure, or data from emerging technologies where a labeled corpus of data to enable supervised learning does not exist are limited by the process of manual labeling. Leveraging the inventive systems and methods can accelerate the data classification process of Big Data sets which can promulgate faster decision-making and situational awareness for the end user.

An exemplary embodiment can relate to a method for developing a model to classify data. The method can involve receiving plural data points. The method can involve grouping each data point into one or more groups via a clustering algorithm. The method can involve assigning each data point an index based one or more groups into which each data point is grouped. The method can involve classifying all indexed-data points of a group and labelling the classified indexed-data points of the group with the same label.

An exemplary embodiment can relate to a system for developing a model to classify data. The system can include a processor. The system can include computer memory having instructions stored thereon that when executed will cause the processor to: receive plural data points; group each data point into one or more groups via a clustering algorithm; assign each data point an index based one or more groups into which each data point is grouped; store plural indexed data points in memory; and receive a label for a group and label each indexed-data points of the group with that label, the label being based on a classification of all indexed-data points of the group.

An exemplary embodiment can relate to a method for classifying data. The method can involve receiving incoming data points. The method can involve comparing the incoming data points to a corpus of labelled data points, the corpus of labelled data points including data points that have been grouped into a group via a clustering algorithm and each data point of the group labelled with a same label. The method can involve labeling an incoming data point with a label based on a match between the incoming data point and a labelled data pack.

An exemplary embodiment can relate to a system for classifying data. The system can include a processor. The system can include computer memory having instructions stored thereon that when executed will cause the processor to: receive incoming data points; compare the incoming data points to a corpus of labelled data points, the corpus of labelled data points including data points that have been grouped into a group via a clustering algorithm and each data point of the group labelled with a same label; and label an incoming data point with a label based on a match between the incoming data point and a labelled data pack.

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIG. 1 shows an exemplary system configuration;

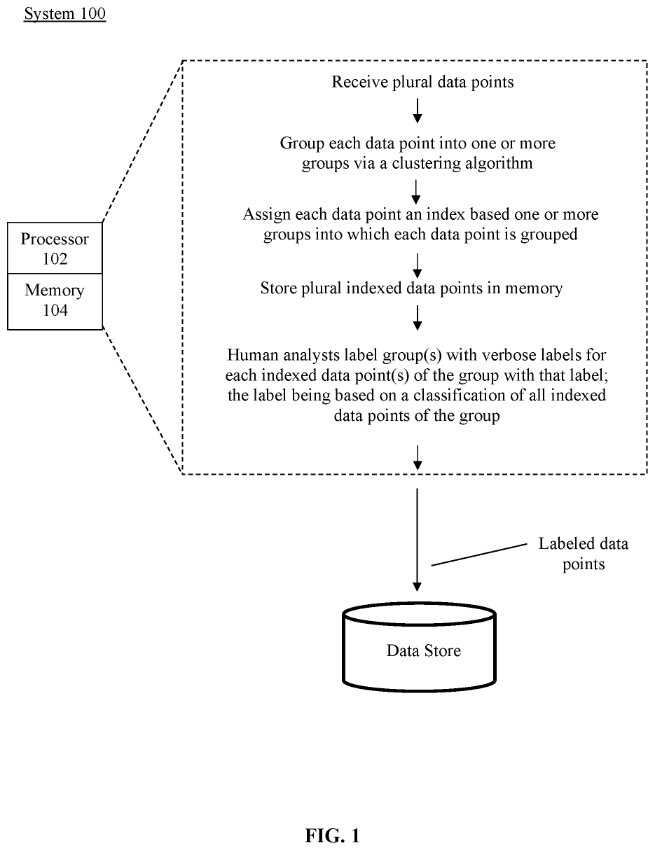

FIG. 2 shows an exemplary process flow; and

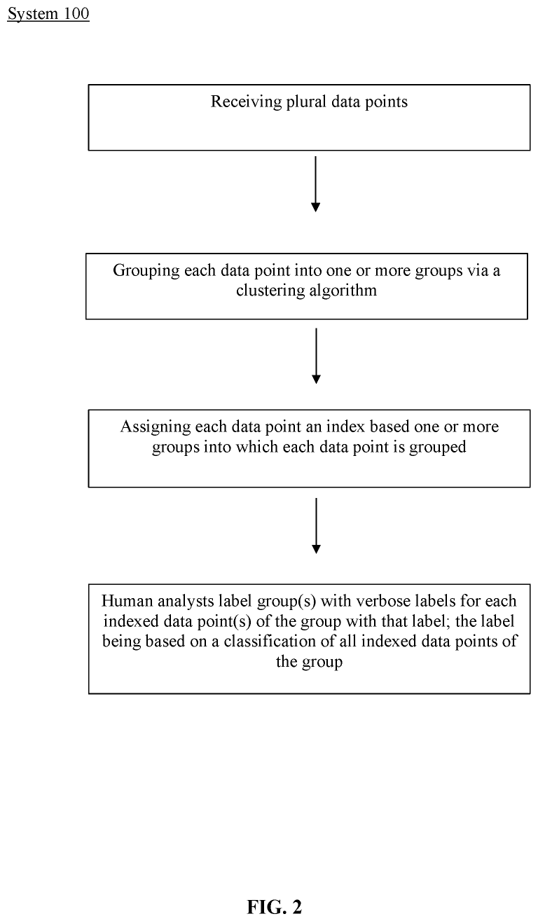

FIG. 3 shows an exemplary system architecture diagram.

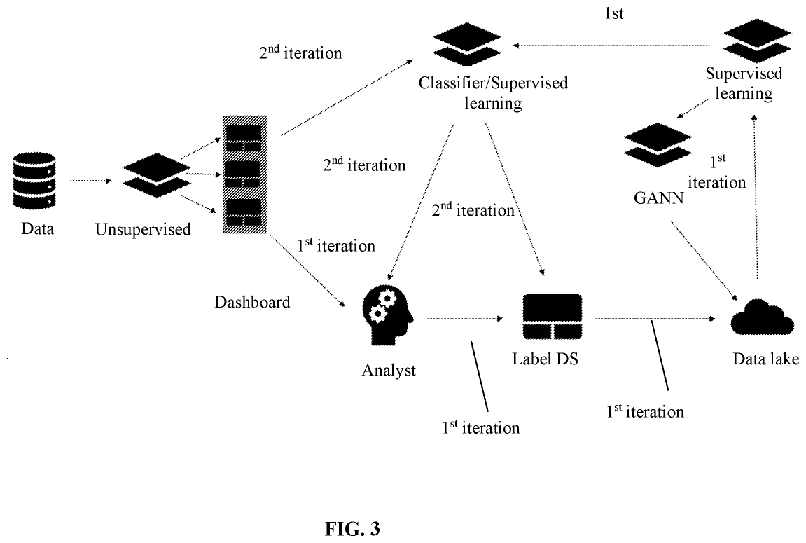

### DETAILED DESCRIPTION

Embodiments can relate to a system 100 for developing a model to classify data. The system 100 includes usage of tiered unsupervised self-optimizing clustering algorithms to organize data for mass labelling and subsequent usage as training data for supervised machine learning models. The system 100 can include a processor 102. The system 100 can include computer memory 104 having instructions stored therein that when executed will cause the processor 102 to execute any of the method steps or algorithms disclosed herein.

The processor 102 can be any of the processors disclosed herein. The processor 102 can be part of or in communication with a machine (logic, one or more components, circuits (e.g., modules), or mechanisms). The processor 102 can be hardware (e.g., processor, integrated circuit, central processing unit, microprocessor, core processor, computer device, etc.), firmware, software, etc. configured to perform operations by execution of instructions embodied in algorithms, data processing program logic, artificial intelligence programming, automated reasoning programming, etc. It should be noted that use of processors herein can include any one or combination of a Graphics Processing Unit (GPU), a Field Programmable Gate Array (FPGA), a Central Processing Unit (CPU), Tensor Processing Unit (TPU), etc. The processor 102 can include one or more processing modules. A processing module can be a software or firmware operating module configured to implement any of the method steps disclosed herein. The processing module can be embodied as software and stored in memory, the memory being operatively associated with the processor. A processing module can be embodied as a web application, a desktop application, a console application, etc.

The processor 102 can include or be associated with a computer or machine readable medium 104. The computer or machine readable medium can include memory. Any of the memory 104 discussed herein can be computer readable memory configured to store data. The memory can include a volatile or non-volatile, transitory or non-transitory memory, and be embodied as an in-memory, an active memory, a cloud memory, etc. Embodiments of the memory 104 can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc.

The computer or machine readable medium 104 can be configured to store one or more instructions thereon. The instructions can be in the form of algorithms, program logic, etc. that cause the processor 102 to build and implement an embodiment of the model.

The processor 102 can be in communication with other processors of other devices (e.g., a computer device, a database, a server, etc.). Any of those other devices can include any of the exemplary processors disclosed herein. Any of the processors can have transceivers or other communication devices/circuitry to facilitate transmission and reception of wireless signals. Any of the processors can include an Application Programming Interface (API) as a software intermediary that allows two applications to talk to each other. Use of an API can allow software of the processor of the system to communicate with software of the processor of the other device(s), if the processor of the system is not the same processor of the device.

The instructions can cause the processor 102 to receive plural data points. Any one or combination of the plural data points can be unlabeled. The data protocol can be 5G Packet Forwarding Control Protocol (PFCP), for example.

The instructions can cause the processor 102 to group each data point into one or more groups via a clustering algorithm (e.g., K-Means, Clustream, Self Organizing Maps, Fuzzy C means, etc.). The clustering algorithm groups data points based on pattern recognition techniques. Clustering algorithms can be chosen based on viability for the size and dimensionality of the dataset, favoring efficient algorithms such as K-Means. The initial clusters can be created with a significant overestimate of K value and treated as seed clusters. Seed clusters can be combined by a secondary hierarchical clustering algorithm based on information theoretic distortion values. Data with extreme dimensionality can be combatted with custom distance metrics that mitigate high dimensionality contrast loss. After categorization is optimized by the hierarchical clustering algorithm, data can be nominated based on information theoretic entropy values to identify unusual, anomalous, or nefarious data (e.g., system problems or cyber attack vectors). Additionally, the information theoretic entropy can be used to identify the features whose values define a cluster to provide more informative summary information to human analysts.

The instructions can cause the processor 102 to assign each data point an index based one or more groups into which each data point is grouped.

The instructions can cause the processor 102 to store plural indexed data points in memory.

The instructions can cause the processor 102 to receive a label for a group and label each indexed-data points of the group with that label, the label being based on a classification of all indexed-data points of the group. The label is performed by a human analyst, and is explained in more detail later.

The instructions can cause the processor 102 to classify each indexed-data points of a group simultaneously.

The instructions can cause the processor 102 to classify all indexed-data points of a first group and label the classified indexed-data points of the first group with a first label. The instructions can cause the processor 102 to classify all indexed-data points of a second group and label the classified indexed-data points of the second group with a second label.

The instructions can cause the processor 102 to encode each data point before grouping each data point.

The instructions can cause the processor 102 to encode each data point via one-hot encoding (OHE). It is contemplated for the data points that are of use/importance are of discrete values, so the data points can be one-hot encoded. One-hot encoding can include a process of converting categorical data variables so they can be provided to and be of use to machine learning algorithms.

The instructions can cause the processor 102 to perform dimensionality reduction of the encoded data points. Dimensionality reduction can be performed by a self-supervised neural net in the form of an autoencoder. The autoencoder can be a beta variation autoencoder, variational autoencoder, or autoencoder depending on the use case and data. The autoencoder's architecture and hyperparameters can be tuned according to custom performance metrics. These metrics can gauge the autoencoder's ability appropriately separate the data in latent space while maintaining data fidelity and relationship in lower dimensional space. Dimensionality reduction can include transformation of data from a high-dimensional space into a low-dimensional encoded space so that the low-dimensional representation retains some meaningful properties of the original data.

Embodiments can relate to a method for developing a model to classify data. The method can involve receiving plural data points. The method can involve grouping each data point into one or more groups via a clustering algorithm. The method can involve assigning each data point an index based one or more groups into which each data point is grouped. The method can involve classifying all indexed-data points of a group and labelling the classified indexed-data points of the group with the same label. The classifying and labelling of batches of data can be performed by a human analyst. For instance, the human analyst can receive the indexed-data point, which is human legible. The human analyst can then assess the data points and assign verbose tags (labels) to the data points in batches. Thus, the classifying and labelling can involve classifying each indexed-data points of a group simultaneously—e.g., all indexed-data points of a group are classified and labelled at one time. One of the advantages of the inventive system/method is batched labeling, which can significantly increase processing speeds. For instance, instead of classifying and labelling 50 data points sequentially, all 50 data points in a group are simultaneously labelled. As noted above, each data point in a group has been grouped by the processor based on pattern recognition. The human analyst can then review the group of data points and classify and label all data points of the group. Another advantage is that the processor created the groups, and thus the system understand how they are grouped, as opposed to other techniques where the system has to extrapolate why the data is labeled the way it is labeled.

The method can involve classifying all indexed-data points of a first group and labelling the classified indexed-data points of the first group with a first label. The method can involve classifying all indexed-data points of a second group and labelling the classified indexed-data points of the second group with a second label.

The method can involve encoding each data point before grouping each data point.

In some embodiments, encoding each data point can involve on-hot encoding.

The method can involve performing dimensionality reduction of the encoded data points.

Embodiments can relate to a system 100 for classifying data. The system 100 can include a processor 102. The system 100 can include computer memory 104 having instructions stored thereon that when executed will cause the processor 102 to implement any of the method steps or algorithms disclosed herein.

The instructions can cause the processor 102 to receive incoming data points.

The instructions can cause the processor 102 to compare the incoming data points to a corpus of labelled data points, the corpus of labelled data points including data points that have been grouped into a group via a clustering algorithm and each data point of the group labelled with a same label.

The instructions can cause the processor 102 to label an incoming data point with a label based on a match between the incoming data point and a labelled data pack. The data can be categorized by a supervised machine learning system. The labeled data can be used to train a supervised machine learning system. The exact type of architecture of this system can heavily dependent on the data and the use case. An exemplary implementation can include a deep neural net (NN), wherein this NN is trained on previously labeled data. This trained NN can categorize or match incoming new data. This NN can also assign a confidence level to its categorization—e.g., indicate how certain it is in match/categorization. Depending on use case and need, this could be done in a batched or streaming manner.

Embodiments can relate to a method for classifying data. The method can involve receiving incoming data points. The method can involve classification of incoming data by a supervised ML model that had been trained on data labeled by the unsupervised machine learning augmented labelling pipeline.

It will be understood that modifications to the embodiments disclosed herein can be made to meet a particular set of design criteria. For instance, any of the components of the system can be any suitable number or type of each to meet a particular objective. Therefore, while certain exemplary embodiments of the system and methods of using the same disclosed herein have been discussed and illustrated, it is to be distinctly understood that the invention is not limited thereto but can be otherwise variously embodied and practiced within the scope of the following claims.

It will be appreciated that some components, features, and/or configurations can be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiments. Thus, the components, features, and/or configurations of the various embodiments can be combined in any manner and such combinations are expressly contemplated and disclosed by this statement.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning, range, and equivalence thereof are intended to be embraced therein. Additionally, the disclosure of a range of values is a disclosure of every numerical value within that range, including the end points.

What is claimed is:

1. A method for developing a model to classify data, the method comprising:
receiving plural data points;
grouping each data point into one or more groups via a clustering algorithm;
assigning each data point an index based one or more groups into which each data point is grouped; and
classifying all indexed-data points of a group and labelling the classified indexed-data points of the group with the same label.

2. The method of claim 1, wherein:
classifying involves classifying each indexed-data points of a group simultaneously.

3. The method of claim 1, comprising:
classifying all indexed-data points of a first group and labelling the classified indexed-data points of the first group with a first label; and
classifying all indexed-data points of a second group and labelling the classified indexed-data points of the second group with a second label.

4. The method of claim 1, comprising:
encoding each data point before grouping each data point.

5. The method of claim 4, wherein:
encoding each data point involves one-hot encoding.

6. The method of claim 1, comprising:
performing dimensionality reduction of the encoded data points.

7. A system for developing a model to classify data, the system comprising:
a processor;
computer memory having instructions stored thereon that when executed will cause the processor to:
receive plural data points;
group each data point into one or more groups via a clustering algorithm;
assign each data point an index based one or more groups into which each data point is grouped;
store plural indexed data points in memory; and
receive a label for a group and label each indexed-data points of the group with that label, the label being based on a classification of all indexed-data points of the group.

8. The system of claim 7, wherein the instruction will cause the processor to:
classify each indexed-data points of a group simultaneously.

9. The system of claim 7, wherein the instruction will cause the processor to:
classify all indexed-data points of a first group and label the classified indexed-data points of the first group with a first label; and
classify all indexed-data points of a second group and label the classified indexed-data points of the second group with a second label.

10. The system of claim 7, wherein the instruction will cause the processor to:
encode each data point before grouping each data point.

11. The system of claim 10, wherein the instruction will cause the processor to:
encode each data point via one-hot encoding.

12. The system of claim 7, wherein the instruction will cause the processor to:
perform dimensionality reduction of the encoded data points.

13. A method for classifying data, the method comprising:
receiving incoming data points;
comparing the incoming data points to a corpus of labelled data points, the corpus of labelled data points including data points that have been grouped into a group via a clustering algorithm and each data point of the group labelled with a same label; and
labeling an incoming data point with a label based on a match between the incoming data point and a labelled data pack.

14. A system for classifying data, the system comprising:
a processor;
computer memory having instructions stored thereon that when executed will cause the processor to:
receive incoming data points;
compare the incoming data points to a corpus of labelled data points, the corpus of labelled data points including data points that have been grouped into a group via a clustering algorithm and each data point of the group labelled with a same label; and
label an incoming data point with a label based on a match between the incoming data point and a labelled data pack.
